(19) United States
(12) Patent Application Publication
(10) Pub. No.: US 2002/0020443 A1
(43) Pub. Date: Feb. 21, 2002

(54) Faucet with pressure balancing valve

(76) Inventor: Jen-Chieh Lee, Taichung Hsien (TW)

Correspondence Address: Harrison & Egbert, 7th Floor, 412 Main Street, Houston, TX, 77002, US

(21) Appl. No.: 09/974,339

(22) Filed: Oct. 10, 2001

Related U.S. Application Data
(63) Continuation-in-part of application No. 09/624,412, filed on Jul. 24, 2000.

(51) Int. Cl. G05D 11/00

(52) U.S. Cl. 137/100

(57) ABSTRACT

A faucet includes a main body and a switch knob. The main body has a cold water connector, a hot water connector, and a balancing valve member. The switch knob is disposed at the junction of the two water connectors. The two water connectors are provided with a neck portion to accommodate the balancing valve member which is formed of an urging rod, two push seats fastened to the urging rod, and two rolling balls. The cold water flow and the hot water flow are regulated by the balancing valve member.

### RELATED APPLICATION

The present application is a continuation-in-part of U.S. patent application Ser. No. 09/624,412, filed on Jul. 24, 2000, and entitled “FAUCET WITH PRESSURE BALANCING VALVE”, presently pending.

### BACKGROUND OF THE INVENTION

1. Field of the Invention

The present invention relates generally to a faucet, and more particularly to a faucet having, a pressure balancing valve capable of balancing the flow and the pressure of the cold water and the hot water.

2. Description of Related Art

As shown in FIG. 1, a prior art faucet 10 is formed of a switch knob 11, a control valve 12, a cold water connector 13, and a hot water connector 14. The control valve 12 is actuated by-the switch knob II to regulate the distribution of clod water and hot water.

Such a prior art faucet as described above is defective in design because the distribution of cold water and hot water by the control valve is susceptible to a sudden change by the change in the pressure of the water supply, and because the switch knob 11 must be kept adjusting from time to time so as to stabilize the distribution of cold water and hot water.

### BRIEF SUMMARY OF THE INVENTION

The primary objective of the present invention is to provide a faucet which is free from the drawback of the prior art faucet described above.

In keeping with the principle of the present invention, the forgoing objective of the present invention is attained by a faucet comprising a switch knob, a cold water connector, a hot water connector, and a pressure balancing valve which is formed of an urging rod, two push seats, and two spherical bodies. The flow and the pressure of cold water and hot water are properly balanced by the pressure balancing valve so as to stabilize the distribution of cold water and hot water.

### BRIEF DESCRIPTION OF THE SEVERAL VIEWS OF THE DRAWINGS

FIG. 1 shows an exploded view of a faucet of the prior art.

FIG. 2 shows a perspective view of a preferred embodiment of the present invention.

FIG. 3 shows an exploded view of the preferred embodiment of the present invention.

FIG. 4 shows a sectional schematic view of the preferred embodiment of the present invention.

FIG. 5 shows another sectional schematic view of the preferred embodiment of the present invention.

FIG. 6 shows a schematic view of the preferred embodiment of the present invention in action.

FIGS. 7-9 are schematic views of the preferred embodiment of the present invention in action.

FIG. 10 shows a partial sectional view of the preferred embodiment of the present invention.

FIG. 11 shows a schematic view of the water control valve of the present invention in an open position.

FIG. 12 shows a schematic view of the water control valve of the present invention in a closed position.

FIG. 13 shows another schematic view of the water control valve of the present invention in the closed position.

FIG. 14 shows a schematic view of the positions of structural members of the present invention in a closed position.

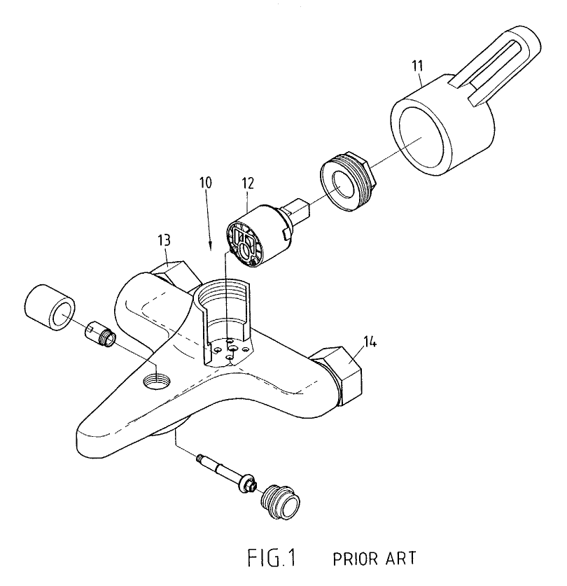

### DETAILED DESCRIPTION OF THE INVENTION

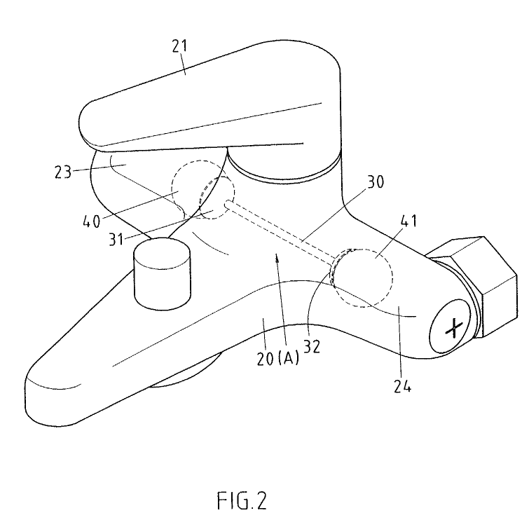

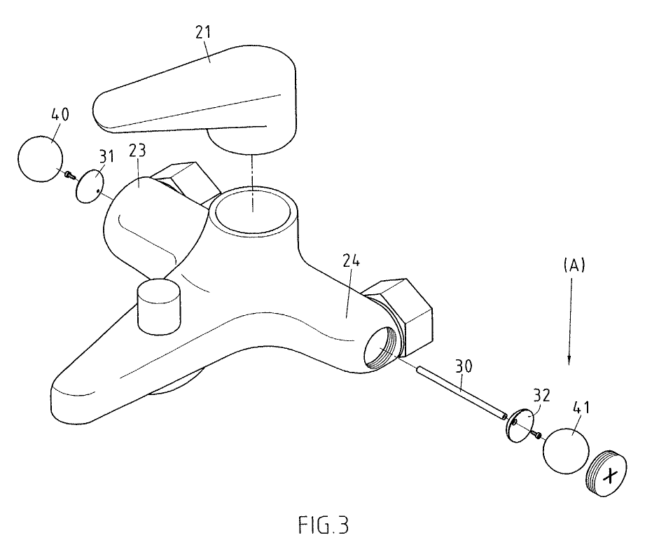

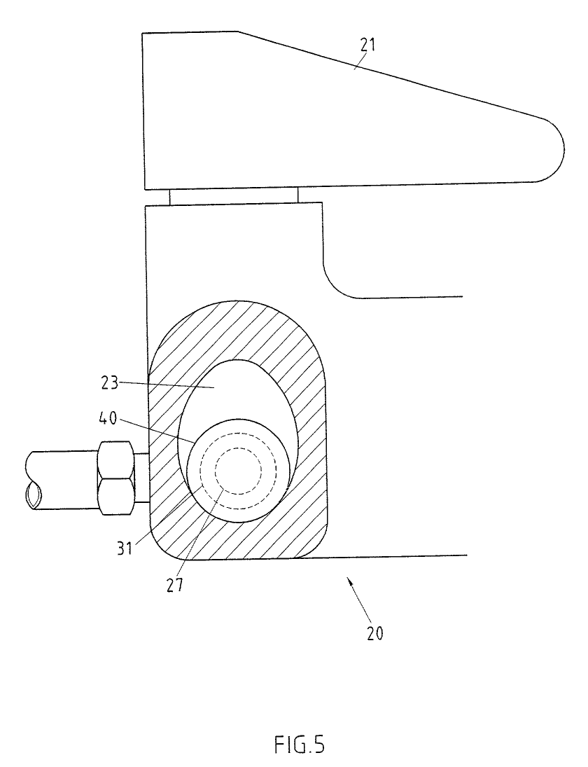

As shown in FIGS. 2-5, a faucet embodied in the present invention comprises a main body 20, a switch knob 21, and a balancing valve member “A”. The main body 20 has a cold water connector 23 and a hot water connector 24. The switch knob 21 is located at the junction of the cold water connector 23 and the hot water connector 24. The cold water connector 23 is provided therein with a first neck portion 25, whereas the hot water connector 24 is provided therein with a second neck portion 26. The neck portions 25 and 26 are intended to facilitate the assembling of the balancing valve member “A”.

The balancing valve member “A” comprises an urging rod 30, two push seats 31 and 32, and two rolling balls 40 and 41.

The urging rod 30 is disposed between the two neck portions 25 and 26.

The two push seats 31 and 32 are fastened to two ends of the urging rod 30. The two push seats 31 and 32 are equal in size to each other and have an outer diameter greater than a narrow end 27 of the neck portions 25 and 26 smaller than a wide end 28 of the neck portions 25 and 26. The two push seats 31 and 32 are respectively movable in the cold water connector 23 and the hot water connector 24.

The two rolling balls 40 and 41 are respectively disposed in the two connectors 23 and 24 such that the rolling balls 40 and 41 are respectively contiguous to the push seats 31 and 32. The two rolling balls 40 and 41 are equal in size to each other and have an outer diameter smaller than the inner diameter of the connector 23 and 24. The two rolling balls 40 and 41 can be pushed by the push seats 31 and 32. The two rolling balls 40 and 41 can be also forced by the water pressure to move to block the neck portions 25 and 26.

The push seats 31 and 32 are made of a material resistant to wear and heat. The push seats 31 and 32 do not cause damage to the rolling balls 40 and 41 by friction. The rolling balls 40 and 41 are made of a stainless steel material. The push seats 31 and 32 may be fastened with to the urging rod 30 by threads.

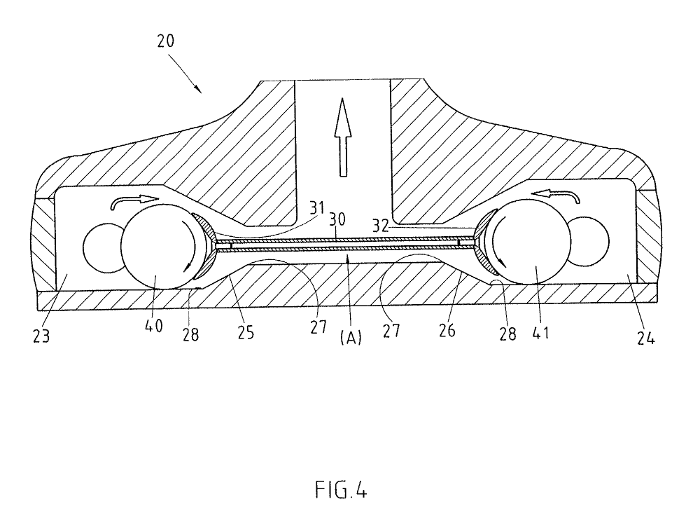

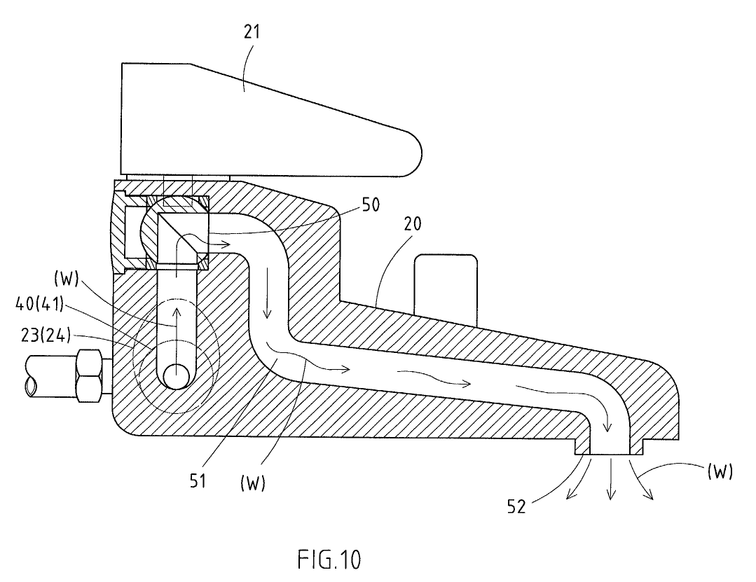

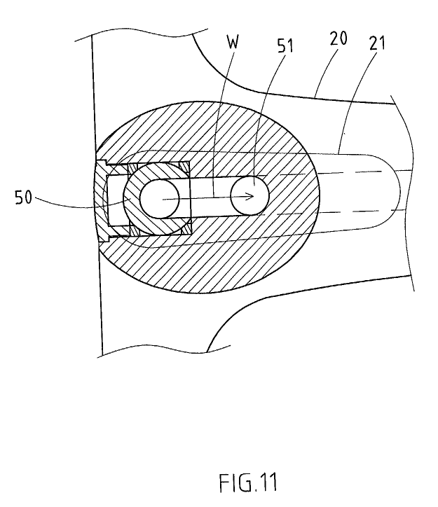

It must be noted here that the urging rod 30 is not directly linked with the switch knob 21. Please refer to FIGS. 10 and 11, the switch knob 21 controls the opening and the closing of a water control valve 50. The action of the urging rod 30 is actuated by the two rolling balls 40 and 41 whose rolling actions are in turn actuated by the flows of the cold water and the hot water, as illustrated in FIG. 4. The switch knob 21 is intended to control the opening and the closing of the water flows. The urging rod 30 is indirectly actuated by the force of water to slide leftwards and rightwards.

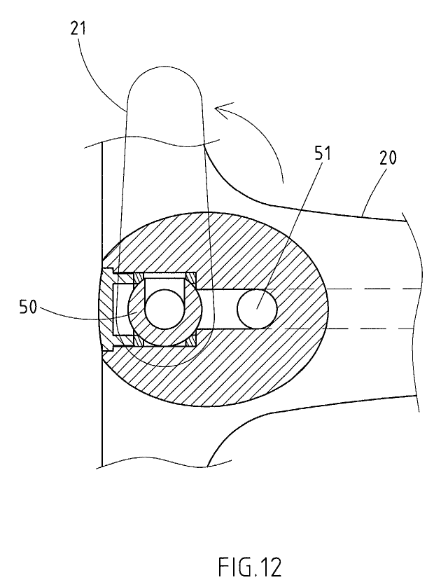

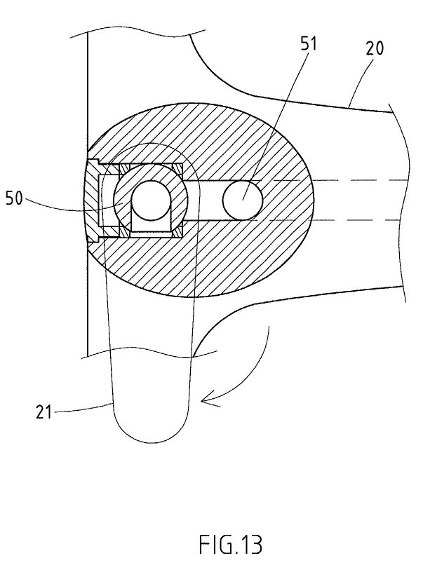

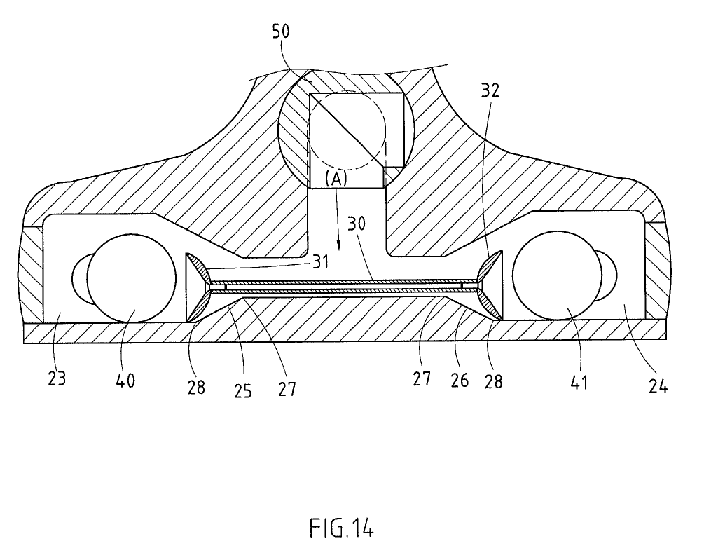

As shown in FIGS. 12, 13, and 14, when the water flow is shut off, the push seats 31 and 32 as well as the two rolling balls 40 and 41 are located at the bottom wall of the connectors 23 and 24 by virtue of their own weights. As the switch knob 21 is. turned on, as shown in FIGS. 10 and 11, the cold water “W” and the hot water “W” are let out from a water discharging port 52 via the clod water connector 23, the hot water connector 24, the water control valve 50, and a water discharging duct 51. In the meantime, the two rolling balls 40 and 41 are exerted on by the water force to roll toward the push seats 31 and 32, as illustrated in FIG. 4. As a result, the cold water flow and the hot water flow are automatically adjusted such that the discharge water has a desired temperature.

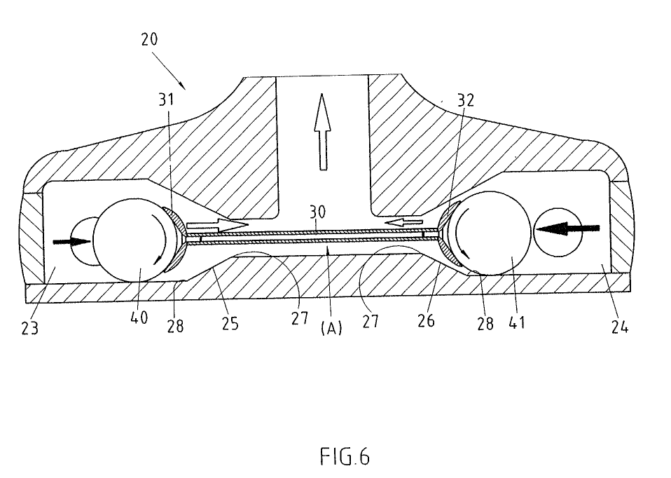

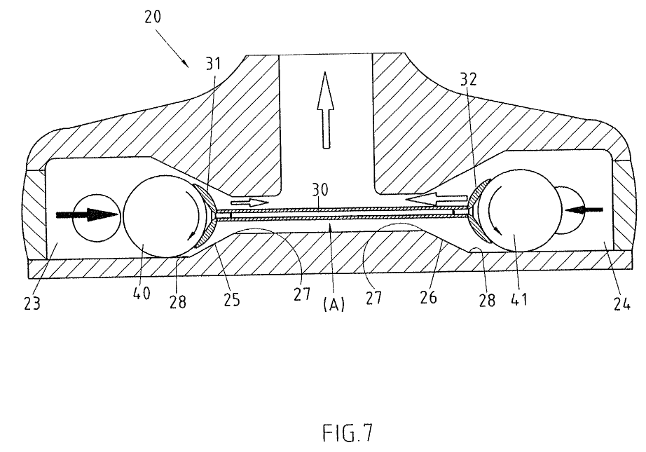

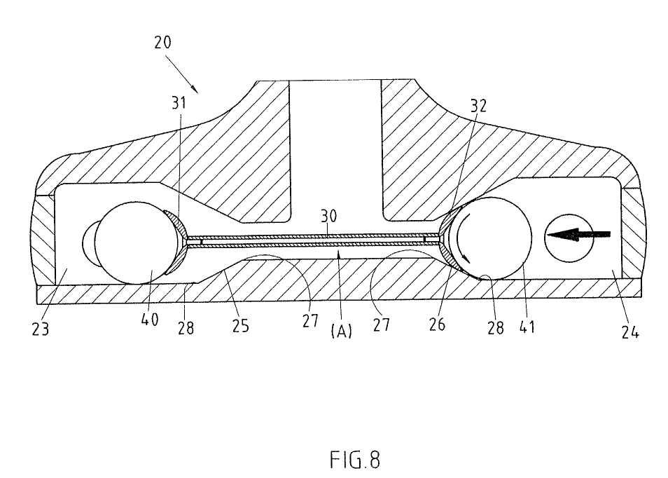

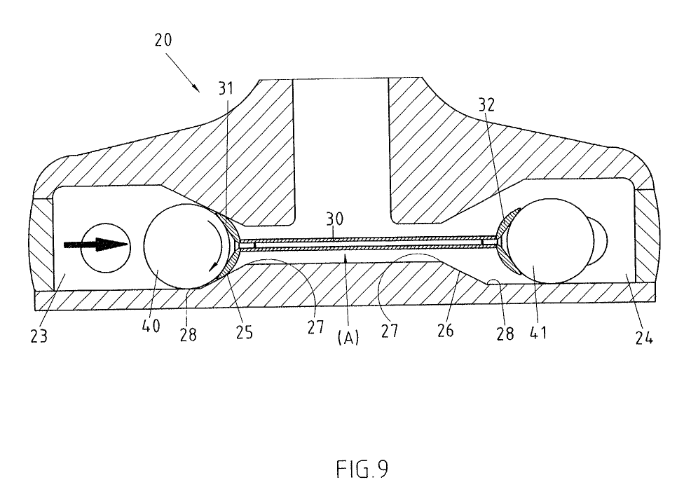

As shown in FIG. 6, when the water pressure of the hot water connector 24 is greater than the water pressure of the cold water connector 23, the rolling ball 41 located at one side of the hot water connector 24 pushes the urging rod 30 to move toward the cold water connector 23, thereby resulting in a gradual reduction in size of the channel between the neck portion 26 and the push seat 32 which is located at one side of the hot water connector 24. In the meantime, the channel between the neck portion 25 and the push seat 31 located at one side of the cold water connector 23 becomes progressively larger. In other words, when the pressure of the hot water connector 24 becomes greater, the size of the channel becomes smaller to reduce the flow of the hot water. Accordingly, when the cold water connector 23 is completely devoid of the water pressure, the water pressure of the hot water connector 24 causes the push seat 32 to obstruct the neck portion 26, as shown in FIG. 8, thereby preventing the hot water from flowing out to cause an excessive increase in the water temperature. As shown in FIG. 7, when the water pressure of the cold water connector 23 is greater than that of the hot water connector 24, the cold water flow is reduced. In the meantime, the hot water flow is increased. When the hot water connector is completely devoid of the water pressure, the water pressure of the cold water connector 23 causes the push seat 31 to obstruct the neck portion 25, as shown in FIG. 9, thereby resulting in the absence of cold water. It is therefore readily apparent that the present invention is capable of an automatic adjustment of the hot water flow and the cold water flow by means of the water pressures of the cold connector 23 and the hot water connector 24.

I claim:

1. A faucet comprising:
a main body having a cold water connector and a hot water connector, said cold water connector having a neck portion, said hot water connector having a neck portion;
a switch knob disposed at a junction of said cold water connector and said hot water connector; and
a balance valve member cooperatively connected to said switch knob such that a movement of said switch knob causes a relative movement of said balance valve member, said balance valve member comprising:
an urging rod disposed between said neck portions of said hot and cold water connectors;
a first push seat fastened to one end of said urging rod and movably located in said neck portion of said cold water connector;
a second push seat fastened to an opposite end of said urging rod and movably located in said neck portion of said hot water connector;
a first rolling ball movably disposed in said neck portion of said cold water connector so as to contact said first push seat; and
a second rolling ball movably disposed in said neck portion of said hot water connector so as to contact said second push seat, said first and second rolling balls being moveable so as to contact the respective push seats under action of a water pressure change passing through the respective hot and cold water connectors so as to regulate a water flow through the respective neck portions.

2. The faucet of claim 1, each of said first and second push seats being formed of a heat resistance and wear resistant material.

3. The faucet of claim 1, each of said first and second push seats being fastened by threads to said urging rod.

4. The faucet of claim 1, each of said first and second rolling balls being formed of a stainless steel material.
